(19) United States
(12) Patent Application Publication
(10) Pub. No.: US 2025/0096311 A1
(43) Pub. Date: Mar. 20, 2025

(54) Chloride electrolytes for solid state lithium ion batteries and methods therefor

(71) Applicants: Alliance for Sustainable Energy, LLC, Golden, CO (US); Colorado School of Mines, Golden, CO (US)

(72) Inventors: Christopher Linfield ROM, Westminster, CO (US); Philip Andrew YOX, Morrison, CO (US); Trevor Russell MARTIN, Boulder, CO (US); Annalise Elizabeth MAUGHAN, Westminster, CO (US)

(21) Appl. No.: 18/886,265

(22) Filed: Sep. 16, 2024

Related U.S. Application Data
(60) Provisional application No. 63/582,771, filed on Sep. 14, 2023.

(51) Int. Cl. H01M 10/0562; C01G 25/00; H01M 10/0525; H01M 50/431

(52) U.S. Cl. CPC H01M 10/0562; C01G 25/006; H01M 10/0525; H01M 50/431; C01P 2002/32; C01P 2002/52; C01P 2002/74; C01P 2006/40; H01M 2300/008

(57) ABSTRACT

Described herein are devices and methods for generating new, lower-cost chloride solid electrolytes useful for lithium ion batteries. The devices replace higher cost, difficult to acquire elements such as Sc with less expensive, readily available elements such as Mg and Zr to form a highly conductive spinel structure. These materials may have a high ionic conductivity on the order of 0.23 mS/cm.

### CROSS-REFERENCE TO RELATED APPLICATIONS

This application claims priority from U.S. Provisional Patent Application No. 63/582,771 filed on Sep. 14, 2023, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Lithium ion batteries are a key technology for renewable or green energy for the storage of solar of wind electricity and for electric vehicles. However, traditional lithium ion configurations utilize flammable liquid electrolytes, which raise safety concerns. Chloride solid electrolytes are an emerging material class for solid-state lithium ion batteries. However, research into these materials so far largely rely on scarce and expensive elements (e.g., Sc). Described herein is a strategy to use cheap and earth abundant elements (Mg, Zr) to provide the structural framework through which Li ions can move. Furthermore, substantial fractions (>50%) of Mg and Zr used by the USA are sourced within the USA, according to the US Geological Survey. Therefore, this material provides a cost-effective option for solid electrolytes that could be scaled using a domestic supply chain.

The leading solid electrolyte technologies are sulfide-based or chloride-based compounds. Sulfide-based compounds (e.g., Li₅PS₅Cl) tend to exhibit higher ionic conductivity than chloride electrolytes (as high as 10 mS/cm), but are unstable against high-voltage oxide cathodes, leading to battery degradation over time. Chloride electrolytes exhibit ionic conductivity as high as 3 mS/cm and are stable against high-voltage oxide cathodes, but tend to be made of expensive and scarce elements (e.g., Sc), inhibiting commercialization. It can be seen from the foregoing that there remains a need in the art for new, cost effective and reliably sourced chloride solid state electrolytes.

### SUMMARY

Described herein are devices and methods for generating new, lower-cost chloride solid electrolytes useful for lithium ion batteries. The devices replace higher cost, difficult to acquire elements such as Sc with less expensive, readily available elements such as Mg and Zr to form a highly conductive spinel structure. These materials may have a high ionic conductivity on the order of 0.25 mS/cm.

In an aspect, provided is a device comprising a solid electrolyte defined by the formula Li_{2-z}Mg_{1-2z/3}Zr_{z}Cl₄; wherein z is selected from the range of 0.01 to 0.66. The solid electrolyte may also be defined as a composite of x LiCl, y MgCl₂ and z ZrCl₄, wherein each of x, y, and z are selected from the range of 0.1 to 0.9.

In an aspect, provided is a method comprising providing a plurality of compounds comprising LiCl, MgCl₂, and ZrCl₄; and milling the plurality of compounds to form a solid electrolyte defined by the formula Li_{2-z}Mg_{1-2z/3}Zr_{z}Cl₄; wherein z is selected from the range of 0.01 to 0.66.

Optionally, the range of z in the formula Li_{2-z}Mg_{1-2z/3}Zr_{z}Cl₄ may be 0.01 to 0.6, 0.1 to 0.6, 0.2 to 0.6, or 0.4 to 0.6. Additionally, in some embodiments, z may be about 0.2, 0.3, 0.4, 0.5, or 0.6.

The described solid electrolyte may comprise or consist of a phase having a spinel structure characterized by the cubic space group Fd-3 m, wherein said spinel structure exhibits a disordered lithium ion distribution over available tetrahedral and octahedral sites within the lattice.

The phase having the spinel structure may be present in an amount greater than or equal to 80%, 90%, 95%, 98%, or optionally, 99% based on the total weight of the solid material (including secondary phases and impurity phases). In some embodiments, the phase having the spinel structure may be 100% of the total weight.

The solid electrolyte may have an ionic conductivity greater than or equal to 0.05 mS/cm, greater than or equal to 0.10 mS/cm, greater than or equal to 0.15 mS/cm, greater than or equal to 0.23 mS/cm. In some embodiments, the solid electrolyte has an ionic conductivity of about 0.23 mS/cm.

The device may further comprise an anode, a cathode, wherein the electrolyte is positioned between the anode and the cathode. The device may be a Li ion battery. The solid state electrolyte may be or be useful as a catholyte in an all solid state Li ion battery.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 provides a diagram illustrating the crystal structure based on the percentage of cation, for Li, Zr and Mg chlorides.

FIG. 2 provides powdered x-ray diffraction data for various data points of z in the formula Li_{2-z}Mg_{1-2z/3}Zr_{z}Cl₄.

FIG. 3 illustrates the reduced cost of Mg and Zr versus In and Sc by comparing chloride materials cost in $/mol.

FIG. 4 provides electrochemical impedance spectroscopy Li_{1.6}Mg_{0.4}Zr_{0.4}Cl₄ at various temperatures.

FIGS. 5A-5B summarize the ionic conductivity (extracted from electrochemical impedance spectroscopy measurements) as a function of temperature for Li₂Mg_{1/3}Zr_{1/3}Cl₄, Li_{1.43}Mg_{0.14}Zr_{0.57}Cl₄, Li_{1.60}Mg_{0.40}Zr_{0.40}Cl₄, Li_{1.78}Mg_{0.67}Zr_{0.22}Cl₄, Li_{1.90}Mg_{0.86}Zr_{0.09}Cl₄ along with Li₂MgCl₄ and Li₂ZrCl₆.

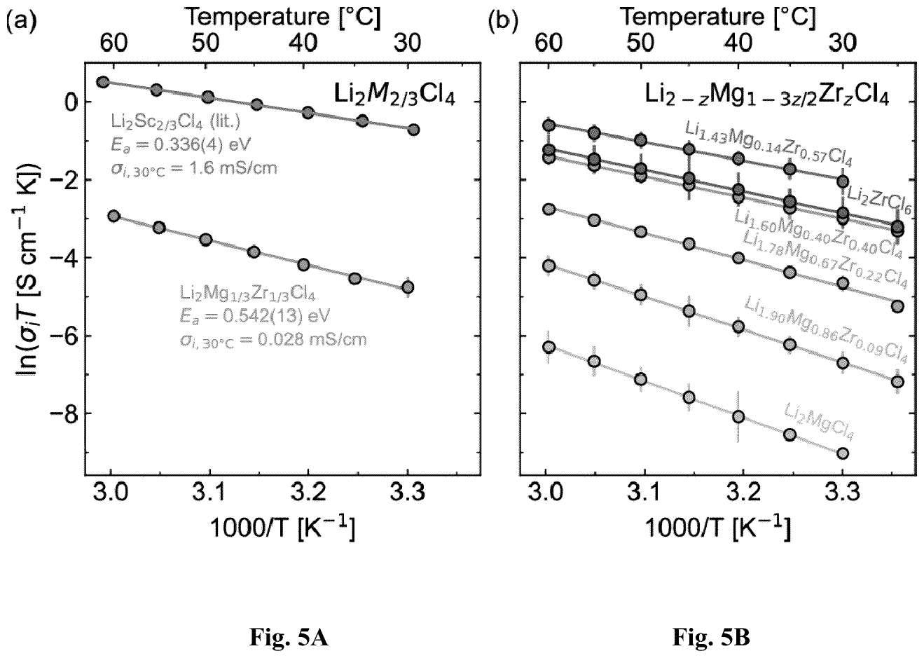

FIGS. 6A-6C summarize the ionic conductivity of Li—Mg—Zr—Cl phases at 30° C. and the activation energy for ionic conductivity for these materials.

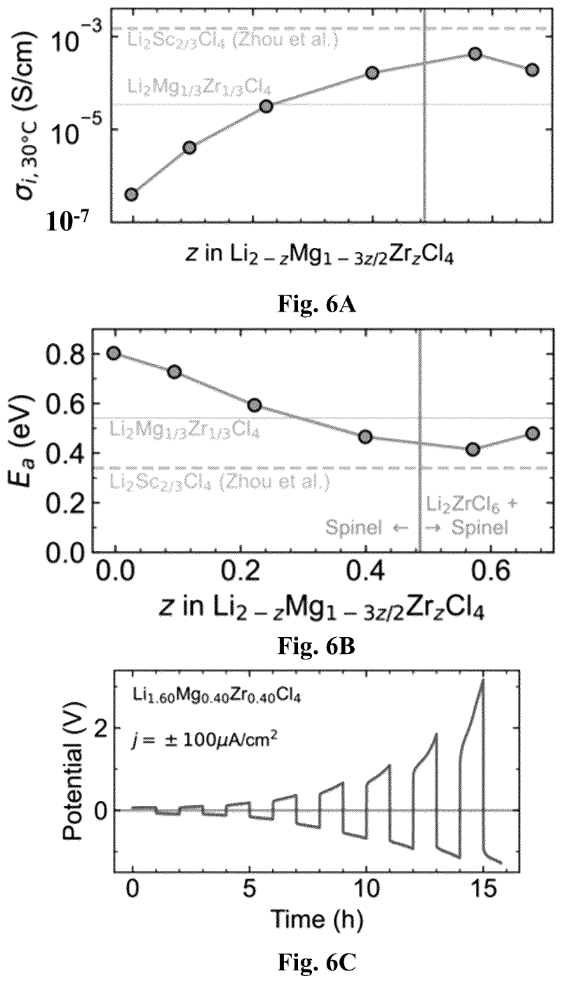

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present application is directed towards a chloride electrolyte made from low-cost compounds (LiCl, MgCl₂, and ZrCl₄) and exhibiting commercially relevant ionic-conductivity. The material is prepared by ball-milling to form a series of Li_{2-z}Mg_{1-2z/3}Zr_{z}Cl₄ compounds where z varies from 0.0 to 0.4. Electrochemical impedance spectroscopy (EIS) measurements indicate that the material exhibits conductivity on the order of 0.23 mS/cm, unoptimized. This value is competitive with the Li₂ZrCl₆ compound that is currently the lowest-cost chloride-based electrolyte. This material may serve as a “catholyte” component of an all-solid-state battery, providing an electronically insulating but ionically-conductive material that is stable against transition metal oxide cathodes.

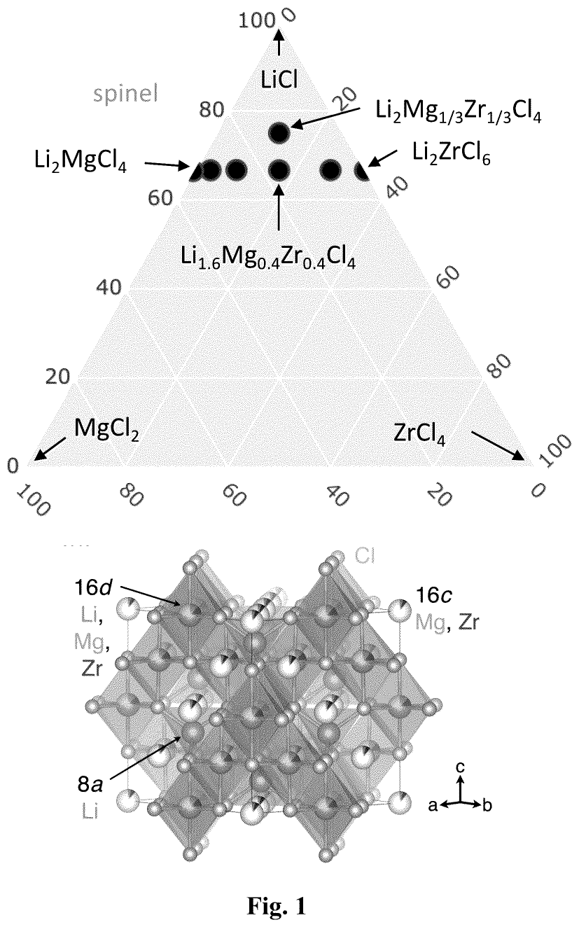

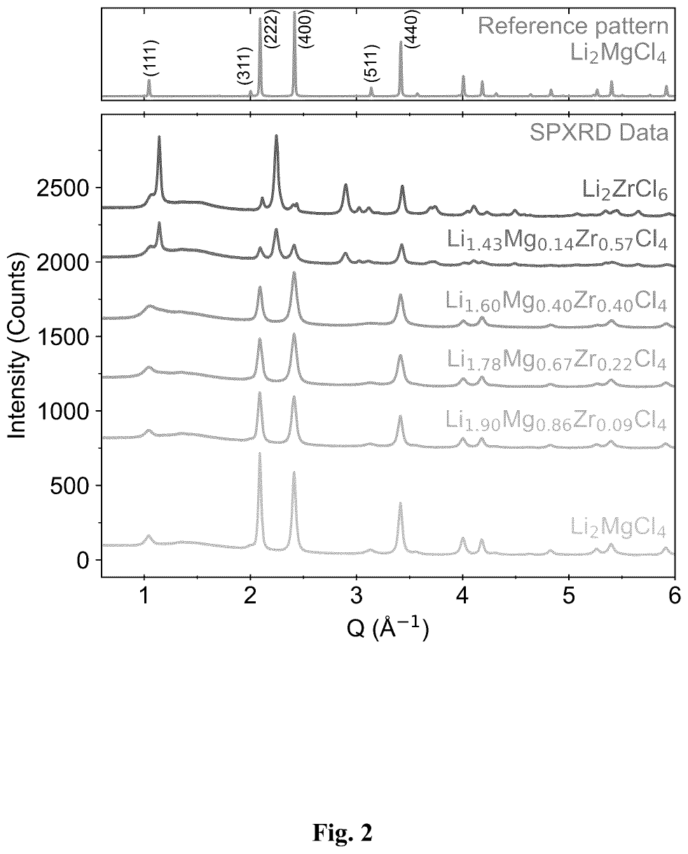

FIGS. 1-2 provide a concentration diagram and powder x-ray diffraction data for the formula Li_{2-z}Mg_{1-2z/3}Zr_{z}Cl₄. This data indicates that a spinel structure is present as high as z=0.4, providing the formula Li_{1.6}Mg_{0.4}Zr_{0.4}Cl₄.

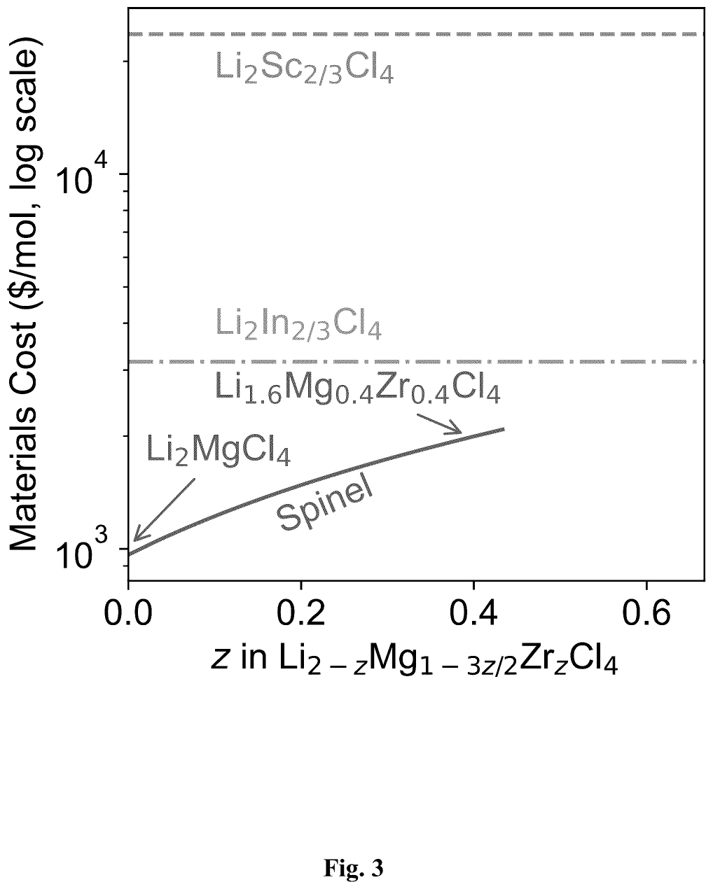

FIG. 3 provides cost analysis for cation components for solid state electrolyte applications. It is noted that Mg and Zr are orders of magnitude less expensive the other common cation sources, including In and Sc.

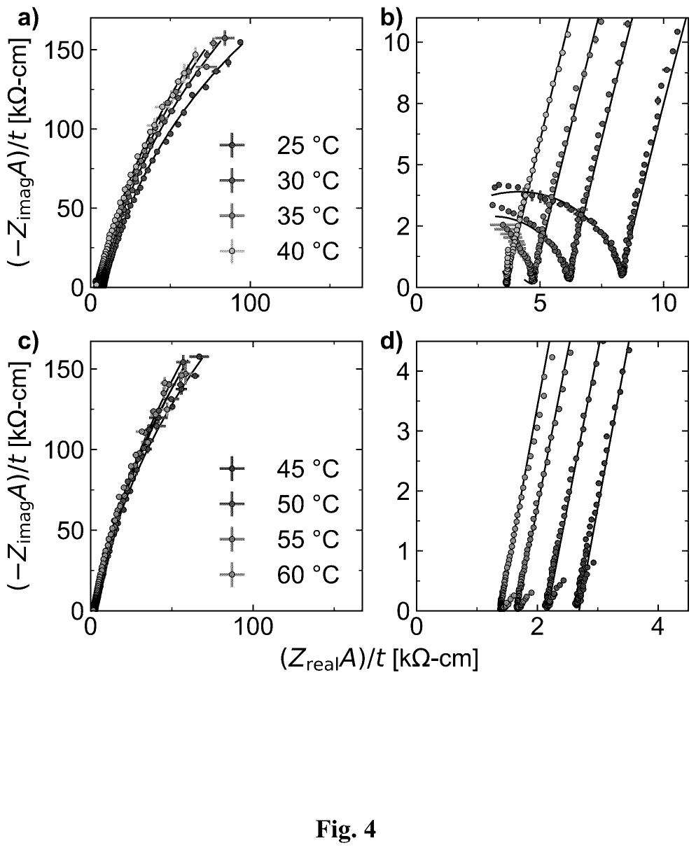

Electrochemical impedance spectroscopy data for Li_{2-z}Mg_{1-2z/3}Zr_{z}Cl₄ where z=0.4 (Li_{1.6}Mg_{0.4}Zr_{0.4}Cl₄) is provided in FIG. 4. Calculating the ionic conductivity (1/resistivity ρ) of Li_{1.6}Mg_{0.4}Zr_{0.4}Cl₄ provides the high ionic conductivity of 0.23 mS/cm at 30° C., which may be further increased via optimization.

The invention may be further understood by the following examples:

Example 1. A device comprising:
a solid electrolyte defined by the formula Li_{2-z}Mg_{1-2z/3}Zr₂Cl₄;
wherein z is selected from the range of 0.01 to 0.66.

Example 2. The device of example 1, wherein z is about 0.4.

Example 3. The device of example 1 or 2, wherein the solid electrolyte comprises a phase having a spinel structure.

Example 4. The device of example 3, wherein the phase having a spinel structure is present in an amount greater than or equal to 80% of the mass of the solid electrolyte.

Example 5. The device of example 3, wherein the phase having a spinel structure is present in an amount greater than or equal to 95% of the mass of the solid electrolyte.

Example 6. The device of any of examples 1-5, wherein the solid electrolyte has an ionic conductivity greater than or equal to 0.05 mS/cm.

Example 7. The device of any of examples 1-6, wherein the device further comprises:
an anode; and
a cathode;
wherein the solid electrolyte is positioned between the anode and cathode.

Example 8. The device of example 7, wherein the device is a lithium ion battery.

Example 9. The device of example 8, wherein the solid electrolyte is a catholyte in an all solid state lithium ion battery.

Example 10. A method comprising:
providing a plurality of compounds comprising LiCl, MgCl₂, and ZrCl₄; and
milling the plurality of compounds to form a solid electrolyte defined by the formula Li_{2-z}Mg_{1-2z/3}Zr_{z}Cl₄;
wherein z is selected from the range of 0.01 to 0.66.

Example 11. The method of example 10, The device of example 1, wherein z is about 0.4.

Example 12. The method of example 10 or 11, wherein the solid electrolyte comprises a phase having a spinel structure.

Example 13. The method of example 12, wherein the phase having a spinel structure is present in an amount greater than or equal to 80% of the mass of the solid electrolyte.

Example 14. The method of example 12, wherein the phase having a spinel structure is present in an amount greater than or equal to 95% of the mass of the solid electrolyte.

Example 15. The method of any of examples 10-14, wherein the solid electrolyte has an ionic conductivity greater than or equal to 0.05 mS/cm.

Example 16. The method of any of examples 10-15, wherein the step of milling is ball milling.

Example 17. The method of example 16, wherein the step of ball milling is performed for about 10 min at about 500 rpm for about 50 cycles.

Example 18. The method of any of examples 10-17, wherein the solid electrolyte is a catholyte in an all solid state lithium ion battery.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A device comprising:
a solid electrolyte defined by the formula Li_{2-z}Mg_{1-2z/3}Zr_{z}Cl₄;
wherein z is selected from the range of 0.01 to 0.66.

2. The device of claim 1, wherein z is about 0.4.

3. The device of claim 1, wherein the solid electrolyte comprises a phase having a spinel structure.

4. The device of claim 3, wherein the phase having a spinel structure is present in an amount greater than or equal to 80% of the mass of the solid electrolyte.

5. The device of claim 3, wherein the phase having a spinel structure is present in an amount greater than or equal to 95% of the mass of the solid electrolyte.

6. The device of claim 1, wherein the solid electrolyte has an ionic conductivity greater than or equal to 0.05 mS/cm.

7. The device of claim 1, wherein the device further comprises:
an anode; and
a cathode;
wherein the solid electrolyte is positioned between the anode and cathode.

8. The device of claim 7, wherein the device is a lithium ion battery.

9. The device of claim 8, wherein the solid electrolyte is a catholyte in an all solid state lithium ion battery.

10. A method comprising:
providing a plurality of compounds comprising LiCl, MgCl₂, and ZrCl₄; and
milling the plurality of compounds to form a solid electrolyte defined by the formula Li_{2-z}Mg_{1-2z/3}Zr_{z}Cl₄;
wherein z is selected from the range of 0.01 to 0.66.

11. The method of claim 10, The device of claim 1, wherein z is about 0.4.

12. The method of claim 10, wherein the solid electrolyte comprises a phase having a spinel structure.

13. The method of claim 12, wherein the phase having a spinel structure is present in an amount greater than or equal to 80% of the mass of the solid electrolyte.

14. The method of claim 12, wherein the phase having a spinel structure is present in an amount greater than or equal to 95% of the mass of the solid electrolyte.

15. The method of claim 10, wherein the solid electrolyte has an ionic conductivity greater than or equal to 0.05 mS/cm.

16. The method of claim 10, wherein the step of milling is ball milling.

17. The method of claim 16, wherein the step of ball milling is performed for about 10 min at about 500 rpm for about 50 cycles.

18. The method of claim 10, wherein the solid electrolyte is a catholyte in an all solid state lithium ion battery.
